(19) United States
(12) Patent Application Publication
(10) Pub. No.: US 2014/0359488 A1
(43) Pub. Date: Dec. 4, 2014

(54) Centralized Management of Link Data for Multiple Applications, Computers and Resources, through Operating Systems and Networked Storage Services

(71) Applicant: Microsoft Corporation, Redmond, WA (US)

(72) Inventors: Eric Bahna, Seattle, WA (US); Anshul Rawat, Kirkland, WA (US); Aaron Butcher, Redmond, WA (US); Joshua Kaplan, Seattle, WA (US); Brett Waldbaum, Sammamish, WA (US); Daniel Wood, Maple Valley, WA (US); Yuan-Chou Chung, Bellevue, WA (US); Mary-Lynne Williams, Seattle, WA (US); Ana Lilia Otero Diaz, Woodinville, WA (US)

(21) Appl. No.: 13/905,077

(22) Filed: May 29, 2013

(51) Int. Cl. G06F 3/0481

(52) U.S. Cl. CPC G06F 3/0481
USPC 715/760

(57) ABSTRACT

An operating system of a computer provides an interface, such as an application programming interface, through which applications on that computer can store link data in a consistent format across applications and resources. Thus, when an application stores link data, it sends a command to the operating system providing the link data, invoking a command to store the link data. When an application retrieves link data, it sends a command to the operating system to retrieve link data. Thus, an application can store link data for a history of resources accessed, favorite resources accessed, and other types of resources to be accessed. As a result, the operating system provides a single mechanism for a heterogeneous set of applications and a heterogeneous set of resources to store link data in a single repository.

### BACKGROUND

Most computer programs which allow a computer to access resources on a computer network, such as browser applications through which a computer accesses the Internet, allow users to store, on the computer, data used to access resources that they access frequently or otherwise would like to remember to be able to access again. Such data to access a resource is distinct from a path and file name in a file system for the computer, as such file names are in the file name space of the computer's file system. Other resources, such as web pages on the Internet, are accessed using data outside the file name space of the file system of the operating system of the computer. Data used to access such resources on a network typically is in the form of a uniform resource locator (URL) or uniform resource indicator (URI). The data stored by applications is commonly called a “bookmark” or “favorite” or “link” or “history” or the like. Herein, the data used to access a resource on a network is called “link data,” an example of which is a URL.

Link data commonly is stored on a computer separately for each application. For example, a browser application may store its link data in one or more data files in a directory or path in the file system of the computer on which the browser application is installed. Other applications in turn store their link data in one or more different data files in different directories or paths in the file system. If a user has multiple computers, each computer also has applications that store their own link data.

### SUMMARY

This Summary introduces selected concepts in simplified form that are further described below in the Detailed Description. This Summary is intended neither to identify key or essential features of the claimed subject matter, nor to limit the scope of the claimed subject matter.

Using conventional applications, users access links using the applications through which the links are stored. Thus, users tend to replicate link data in different applications on different devices. Also, remembering the application in which the link data is stored can be difficult. Alternatively, users can use an application that stores links, and data accessed from resources using such links, for later reading.

To address such problems, an operating system of a computer provides an interface, such as an application programming interface, through which applications on that computer can store link data in a consistent format across applications and resources. Thus, when an application stores link data, it sends a command to the operating system providing the link data, invoking a command to store the link data. When an application retrieves link data, it sends a command to the operating system to retrieve link data. Thus, an application can store link data for a history of resources accessed, favorite resources accessed, and other types of resources to be accessed. As a result, the operating system provides a single mechanism for a heterogeneous set of applications and a heterogeneous set of resources to store link data in a single repository.

The computer can connect over a computer network to a networked storage service, associated with a user account, in which such link data can be stored. In the event that multiple computers are associated with that user account, the networked storage service and each computer can synchronize their sets of link data. Thus, a user who accesses a user account with different computers has the same set of link data on the different computers. This link data in turn is available to multiple applications through the respective operating systems of those computers. Such link data also can be shared with others.

The link data is stored in a consistent format across multiple applications and multiple resources. This format can include the data used to access a resource, such as one or more URL(s), and various metadata. Such metadata can include, for example but not limited to: an indication of the application(s) associated with the link data, one or more time stamps indicating when the resource was accessed, added or last updated, a geographic location of the device when the resource was accessed, a plain text title or description of the resource, and an indication of the device that hosts the application accessing the link, a type of the resource, data from the application such as a name and image associated with the resource, keywords, user entered tags, deadline for reading, and the like. Data from the resource, such as a cache of the data received when the resource was last accessed, or other information, can be stored. An expiration date for the link and/or its metadata also can be set. The applications associated with the link data can include the application that instructed the device to store the link data. This link data format also allows multiple URL(s) to be associated with a resource, while providing link data for different applications to access the same resource or equivalent resources.

In addition, a computer program dedicated to management of link data, herein called a “link manager,” also can be provided. The computer program can be part of the operating system of a computer or an application running on the computer that communicates with the operating system to access link data. This link manager allows a user to access, search, view and manage various link data. The link manager can include a graphical user interface through which the user can search, view and manipulate link data. For example, the graphical user interface can provide a variety of ways to search, filter and sort link data for display, using the various metadata from the link data. As an example, link data can be sorted and grouped by date of last access. Link data for a resource can be displayed in a format that indicates to a viewer a title of the resource, a time it was last accessed and the application and/or device through which the resource was accessed. Link data can be filtered, for example, by date, application, read or unread status, resource type, keywords, user entered tags, and the like. The link manager can prompt a user to install an application on a device, if link data is available for an application that is not installed on the device.

In the following description, reference is made to the accompanying drawings which form a part hereof, and in which are shown, by way of illustration, specific example implementations of this technique. It is understood that other embodiments may be utilized and structural changes may be made without departing from the scope of the disclosure.

### DESCRIPTION OF THE DRAWINGS

FIG. 1 is a block diagram of an example computer in which link data from multiple applications is managed by the operating system.

FIG. 2 is a block diagram of an example implementation where link data from multiple computers is managed by a networked storage service.

FIG. 3 is diagram of an example data structure for storing link data.

FIG. 4 is a flow chart of an example implementation of sharing link data among applications.

FIG. 5 is a flow chart of an example implementation of sharing link data among computers.

FIG. 6 is a data flow diagram of an example implementation of a computer with a link manager.

FIG. 7 is a flow chart of an example implementation of a user launching an application through a link manager.

FIG. 8 is a flow chart of an example implementation of a link manager invoking installation of an application.

FIG. 9 is an illustration of an example graphical user interface for accessing link data.

FIG. 10 is an illustration of another example graphical user interface for accessing link data.

FIG. 11 is a block diagram of an example computer with which components of such a system can be implemented.

### DETAILED DESCRIPTION

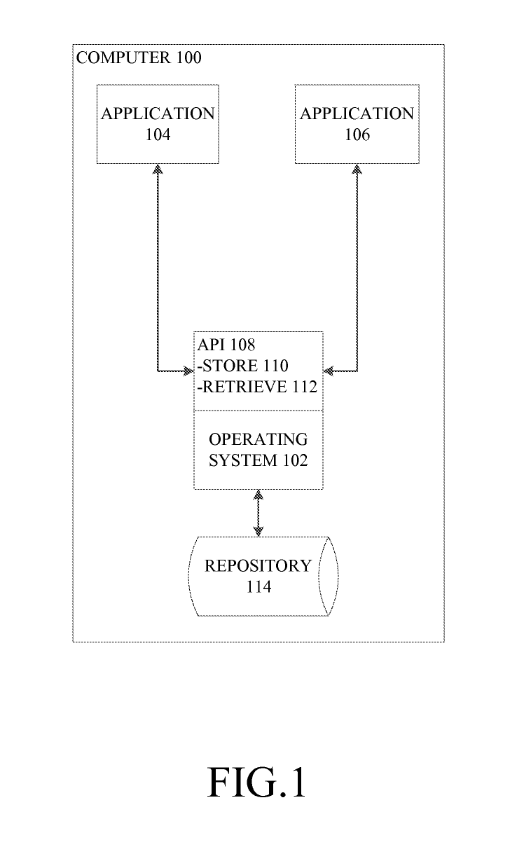

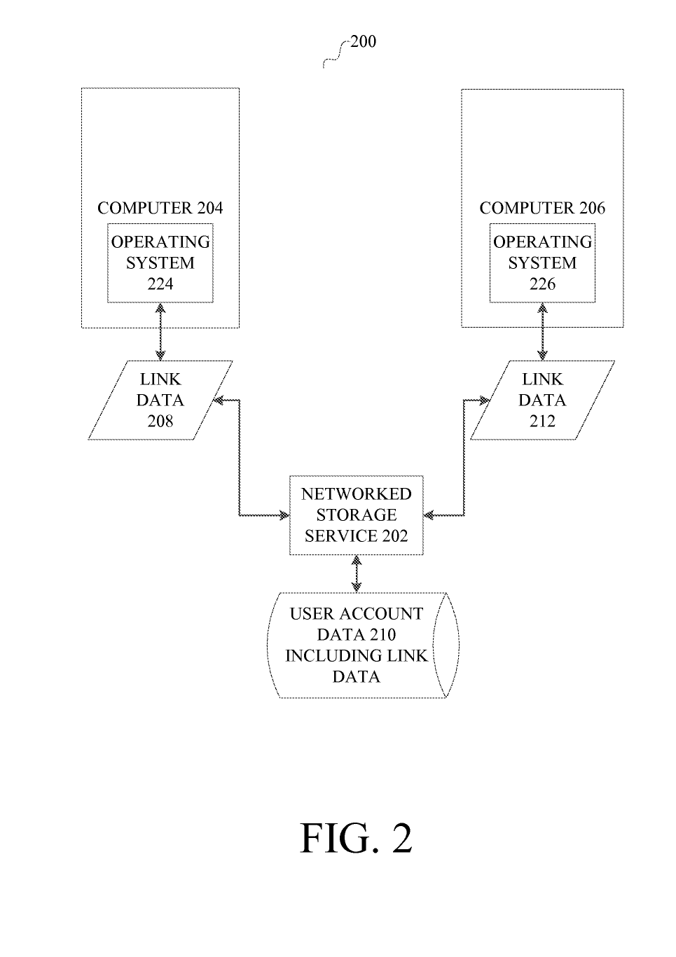

The following section provides an example operating environment in which management of link data for accessing resources on a computer network can be centralized. FIG. 1 illustrates an example computer in which link data from multiple applications is managed by the operating system. FIG. 2 illustrates an example implementation where link data from multiple computers is managed by a networked storage service.

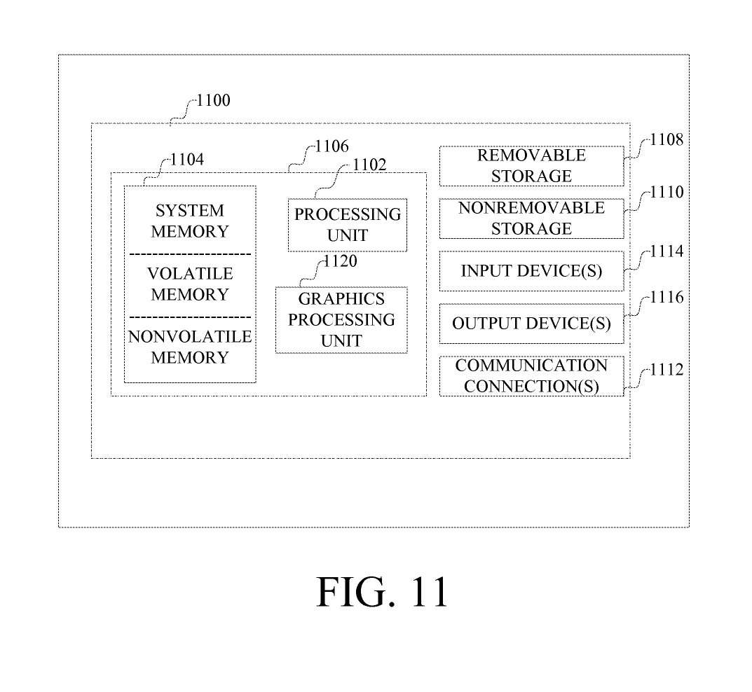

Referring to FIG. 1, a computer 100 includes an operating system 102 with which applications 104 and 106 can interact. The computer 100 can be any conventional general purpose computing device, such as described below in connection with FIG. 11. Applications 104 and 106 are used to access resources on a computer network (not shown), and include applications such as a browser application for access web pages on the internet, and other kinds of applications.

The resources generally are identified using data outside the file name space of the file system of the operating system of the computer. Such data typically identifies a host computer and a name of a resource on that host computer. Such data also can include an indication of a method for accessing a resource on its host computer. An example of such data is a W3C defined standard URL (e.g., http://www.host.com/index.html), which for a web page identifies its host computer using a domain name (e.g., www.host.com), the web page using a path and file name (e.g., “index.html”), and a protocol used to communicate with the host computer to access the web page (e.g., “http”). While it is possible for a link to reference a data file or other resource within the name space of the file system of the computer, the link data in such a case also includes information that indicates that the resource is located within the computer's file system, using a format such as “file:\\path\filename.”

Applications 104 and 106 can use an application programming interface 108 of the operating system to store 110 and retrieve 112 information about links. The operating system 102 maintains this information about links in a repository 114. The repository can be a data file, database or other form of structured storage of information about links such that information about links can be readily stored, searched and retrieved.

Referring to FIG. 2, a computer system 200 includes a networked storage service 202 to which multiple computers, e.g., 204 and 206, connect over a computer network 208. Each computer 204, 206 can be implemented such as described above in connection with FIGS. 1 and 11. Each computer 204, 206 connects to the networked storage service 202 over a computer network, and is associated with a user account with the networked storage service. The network storage service stores link data as part of the user account data 210 stored for a user. In the event that multiple computers 204, 206 are associated with a user account, the networked storage service and each computer can synchronize their sets of link data. In particular, link data 208 from computer 204 is synchronized with link data 210 for the user account. Similarly, link data 212 from computer 206 is synchronized with the link data 210 for the user account. Thus, users who access the user account with different computers have the same set of link data on the different computers. This link data in turn is available to multiple applications on each computer through the respective operating systems 224, 226 of those computers, and is available to be shared with other users.

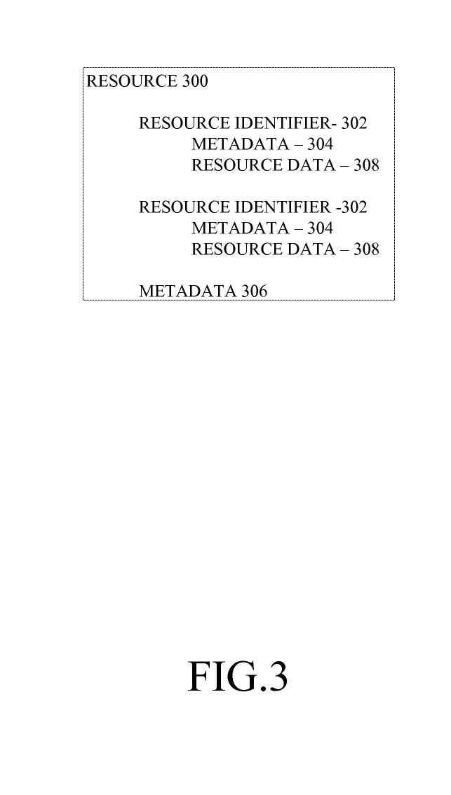

Given this context, an example implementation will be described in more detail in connection with FIGS. 3-10.

FIG. 3 illustrates an example implementation of a data structure that can be used to store link data, such as in the repository 114 (FIG. 1) or the networked storage service as part of user account data 210 (FIG. 2). In one example implementation, link data can be stored in such a data structure using a markup language document stored as a data file, with markup elements designating each field of data. Such files then can be indexed and the index and data files can be used to support a variety of operations.

In the example shown in FIG. 3, for a given resource 300, the link data includes one or more resource identifiers 302. Such an identifier can be a uniform resource locator (URL) or other data that can be used to access the resource. As shown in FIG. 3, link data for a resource can include a plurality of resource identifiers 302. For example, a URL for a desktop based browser application and a URL for a mobile device based browser application can be separately identified. The resources accessed can be identical or equivalent or otherwise related.

For each resource identifier, various metadata 304 can be stored. Such metadata can include, for example but not limited to: an indication of the application(s) associated with the link data, one or more time stamps indicating when the resource was accessed, a geographic location of the device when the resource was accessed, a plain text title or description of the resource, an indication of the device that hosts the application accessing the link, a type of the resource, data from the application such as a name and image associated with the resource, and the like. Data 308 from the resource, such as a cache of the data received when the resource was last accessed, or other information such as an expiration date for the link and/or the metadata, can be stored. The applications associated with the link data can include the application that instructed the device to store the link data. The link data for a resource 300 also can include metadata 306 not associated with a particular resource identifier, such as keywords, user entered tags, deadline for reading, and the like.

In one implementation, the metadata can indicate whether a particular link is marked as private to a user or to a particular application. Such data can be used to prevent sharing of links between users and/or to prevent links of an application from being accessed by another application. Such metadata can be checked by the operating system or link manager or other application that may be invoked when the link data is accessed or shared.

In one implementation, the metadata also can indicate whether a particular link has been marked for deletion. Links that are marked for deletion can be removed from search results, and sorting and filtering, and other display operations. Links that are marked for deletion can be presented in a separate graphical user interface, for searching, sorting and filtering, and selection, though which links can be undeleted or permanently deleted and purged form the system.

One implementation, in which link data is stored in a data file in the eXtensible Markup Language (XML) format, will now be described in more detail. In such a format, a markup language defines a hierarchical structure of data. Markup elements, defined by labeled start tags and end tags, delineate different data.

In this example format, the data is stored in two parts, delineated by separate markup elements: indexed data and unindexed data. The indexed data includes application information and metadata, also delineated by separate markup elements, where the metadata is defined as a sequence of properties, with each property being defined as a key/value pair within a property markup element, e.g., “<property> <key> key name</key> <value> key value </value> </property>”.

The indexed properties for a link, in this example, include a title, name of the source application providing the link, summary text, date acquired, a deleted flag, a date deleted, and an archive flag. A read/unread flag and a date read also may be stored.

The unindexed metadata for a link, in this example, includes a unique identifier for the link, a URI for the link, a name for the application, image properties for any image associated with the link, and logo properties for any icon associated with the application that provided the link. A creation date and deletion date also can be stored.

This XML data can be stored in a data file for persistent storage of data to be used by the operating system or a link manager application as described below. The data in such an XML file can be processed by the operating system, link manager, or other application into a runtime representation of the data in another data structure.

It should be understood that the stored link data is subject to a variety of possible implementations in terms of the data format and content and storage mechanism, and the foregoing is merely an example.

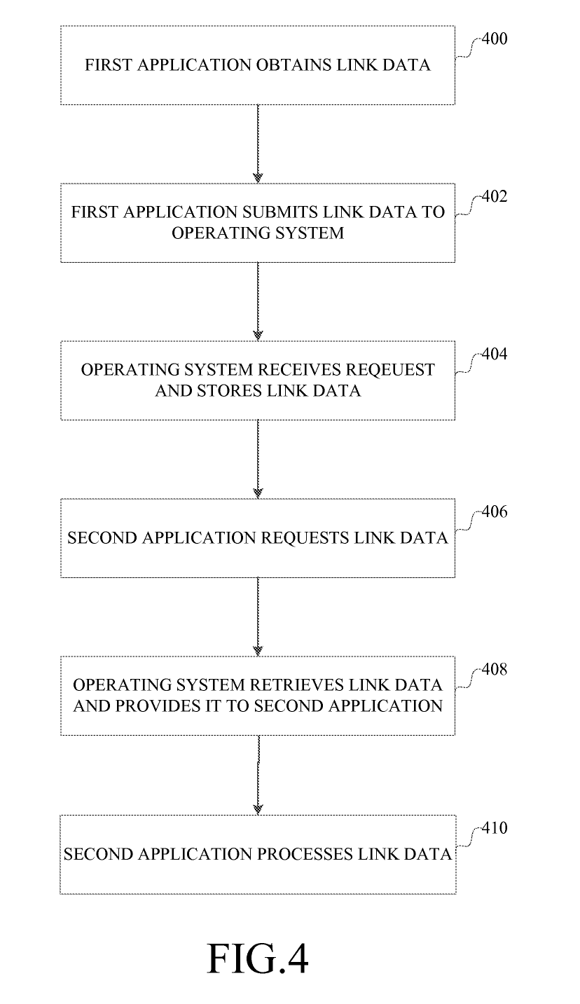

Referring now to FIG. 4, an example implementation of operation of a computer such as shown in FIG. 1 will now be described in connection with a use case of applications sharing access to link data through the operating system.

An application obtains 400 data to access a resource, such as a URL. For example, a browser application receives a URL. The application then submits 402 this link data to the operating system to be stored. For example, the browser application can store the link data in its history, or the user can instruct the browser application to store the link as a “bookmark” or “favorite.” The operating system receives 404 the request and stores the link data. This link data now can be shared with other applications. For example, a second application can request 406 link data from the operating system. The operating system, in response to the request, retrieves 408 link data and provides the link data to the requesting application. The application can then process 410 the received link data. The application, for example, can be a different browser application from which a user can select a link from a list of bookmarks or favorites.

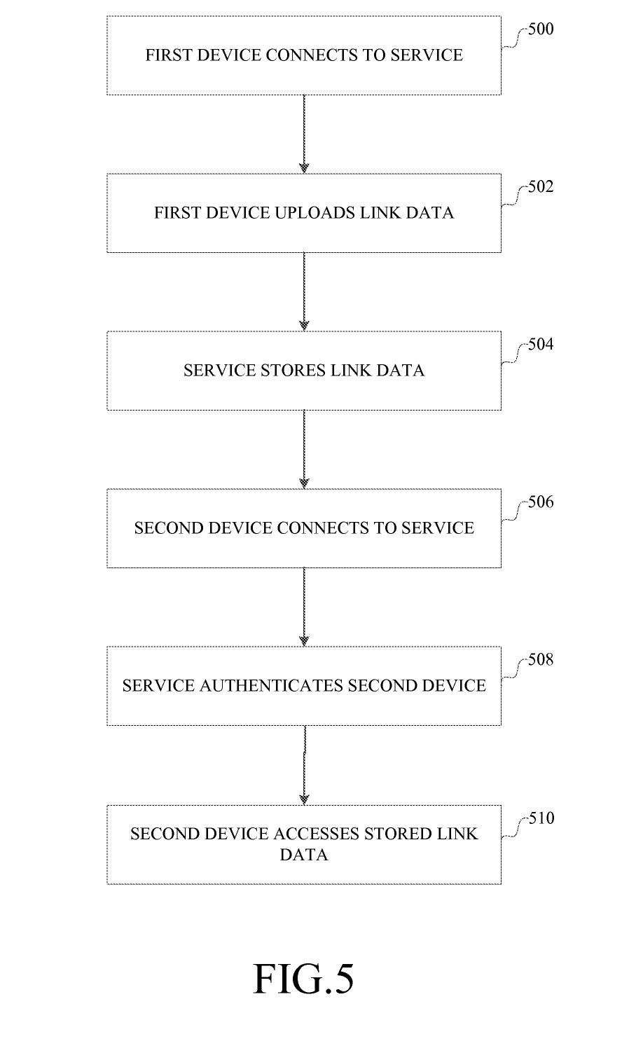

FIG. 5 describes an example implementation of operation of two computers connected to a networked storage service, such as shown in FIG. 2, in connection with a use case of two devices associated with the same user account that synchronize repositories of link data.

In FIG. 5, a first device connects 500 to the networked storage service. This device uploads 502 its link data to the user account with which the device is associated. The networked storage service then stores 504 the uploaded link data, synchronizing it with any previously uploaded link data. A second device connects 506 to the networked storage service. This networked storage service authenticates 508 the device, using the same user account as the first device. The second device then accesses 510 the stored link data, for example, by requesting the link data from the user account, which in turn is provided by the networked storage service. The second device can thus synchronize its link data with the link data in the user account on the networked storage service.

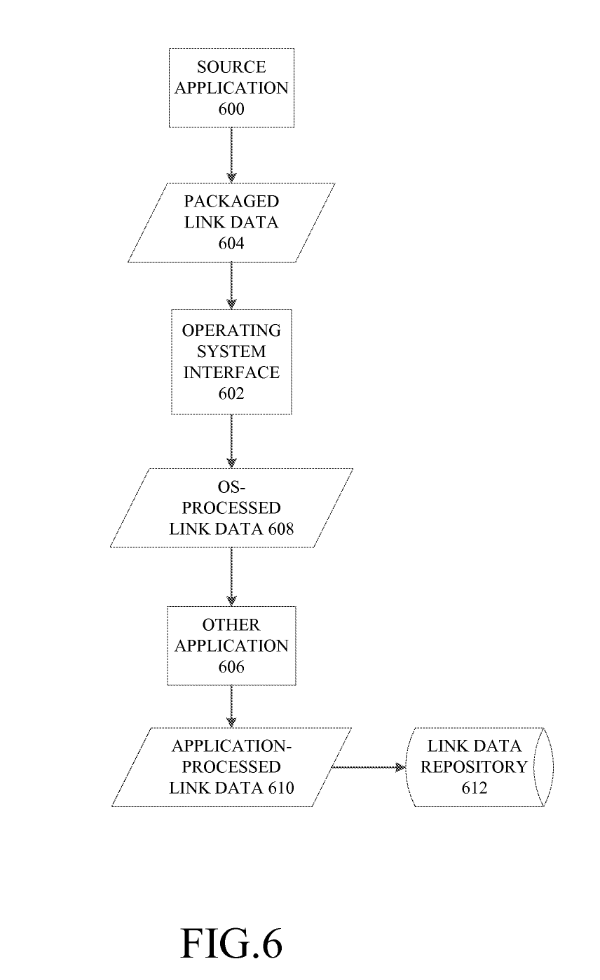

Referring now to FIG. 6, an example implementation of a computer with a link manager will now be described. Such a link manager is a computer program dedicated to management of link data. The computer program can be part of the operating system of the computer or can be an application running on the computer that communicates with the operating system to access link data. This link manager allows a user to access, view and manage various link data.

In one implementation as shown in FIG. 6, an application 600 invokes an interface 602 of the operating system enabling the application 600 to share data with other applications and/or users. The application creates a package of data 604 including various link data. The interface 602 of the operating system presents a graphical user interface to the user, enabling the user to select another application and/or other user, in this case the link manager 606, with which to share the data. The package of data 604 is passed through the operating system interface 602 to the link manager 606 as indicated at 608. In turn, the link manager 606 processes the package data and stores link data 610 in the repository 612. Using this method, an indication of the source application 600 and a time stamp from the operating system of the time the data is shared can be readily generated and stored as part of the link data. In the event the user selects another user, then the operating system interface packages up data 604 into a message to be transmitted to the other user. In another implementation, the operating system provides an application programming interface through which one application can share data directly without presentation of a graphical user interface. Such an implementation can enable sharing without intervention by the user or without prompting the user for a selected recipient after initiating the sharing operation.

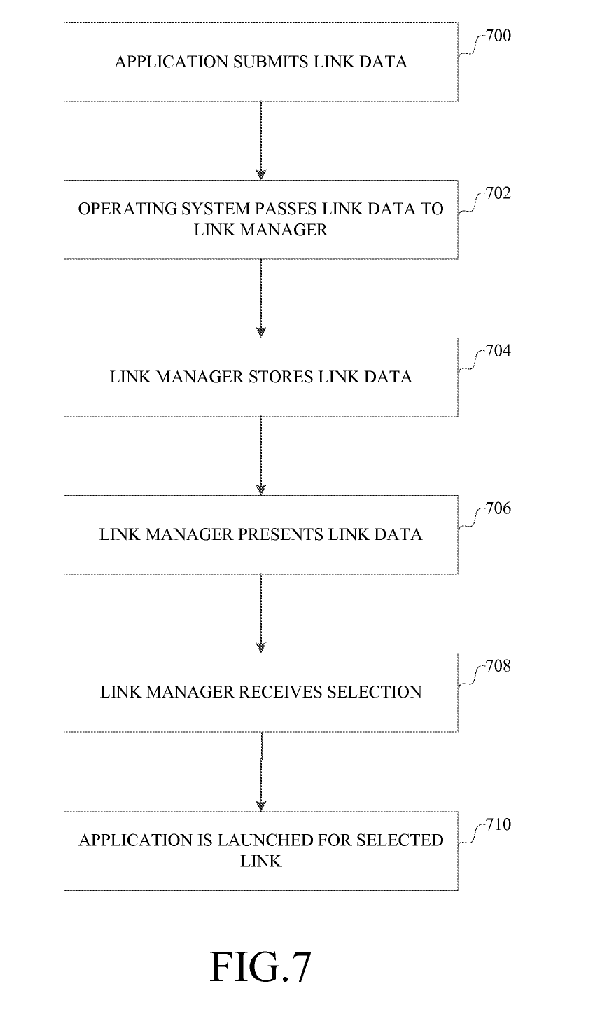

The link manager can include a graphical user interface, examples of which are described below, through which the user can view and manipulate link data. For example, the graphical user interface can present links to a user, and receive an indication of a selected link from the user, and in turn invoke the application that was the source of the link to access the resource represented by the link. An example implementation of such a use case is described by FIG. 7. In particular, an application submits 700 link data to the operating system. The link data is passed 702 by the operating system to the link manager. The link manager stores 704 the link data. The link manager presents 706 to a user links for selection. The link manager receives 708 an indication of a selected link from a user. The link manager then invokes the other application, which launches 710 and uses the link data to access the resource represented by the link.

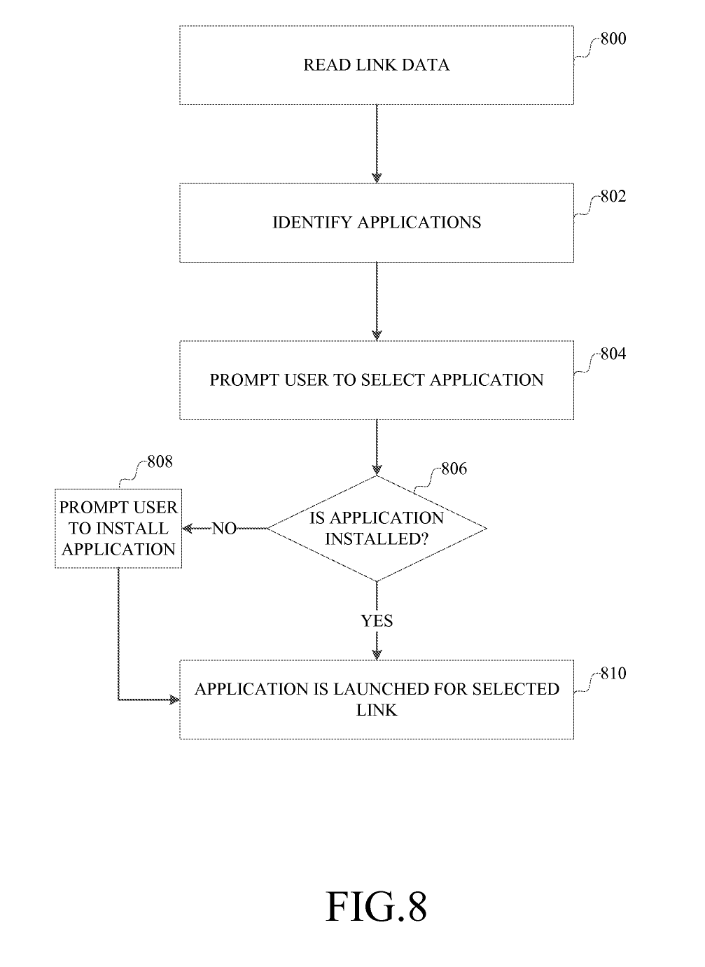

The link manager also can prompt a user to install an application on a device, if link data is available for an application that is not installed on the device. An example implementation of this use case is shown in FIG. 8. Link data is read 800. The applications associated with the link data are identified 802. A user can be prompted 804 to select an application. If the selected application is not installed, as determined at 806, then the user is prompted 808 to install the application. Otherwise the application can be launched 810, using the link data to access the resource with the launched application.

The graphical user interface of the link manager can provide a variety of ways to, search, filter and sort link data for display, using the various metadata from the link data. As an example, link data can be searched for by keyword and field values. Link data also can be sorted and grouped by date of last access. Link data for a resource can be displayed in a format that indicates to a viewer a title of the resource, a time it was last accessed and the application and/or device through which the resource was accessed. Link data can be filtered, for example, by date, application, read or unread status, resource type, keywords, user entered tags, and the like.

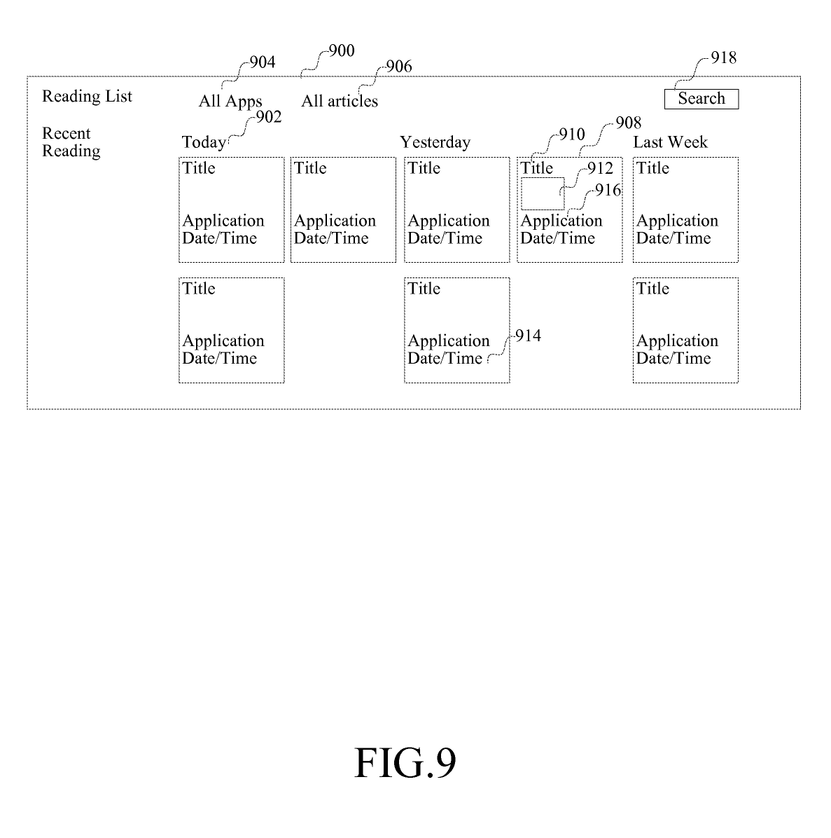

An example graphical user interface 900 is shown in FIG. 9. In this example, links are sorted and grouped by time of creation, such a “recent”, “today” (as shown at 902), “yesterday”, “last week” as so on. Filter options can be selected through manipulating graphical elements on the display, such as shown at “All apps” 904 and “All articles” 906. For example, a user can select links associated with a selected application by manipulating a drop down menu or similar selection mechanism as shown at 904. As another example, a user can select links having a particular status, such as read or unread, by manipulating a drop down menu or similar selection mechanism as shown at 906. A link can be displayed, such as at 908, by a combination of graphical elements that indicate, for example, a title 910, an image 912, a time of access 914, an application 916, associated with a link. Manipulation of this displayed representation of the link, such as a click or touch, causes the associated application to be invoked and to access the resource associated with the link. A search box 918 allows a user to enter keywords which are used to search the link data. Results from a search can be shown in the interface 900.

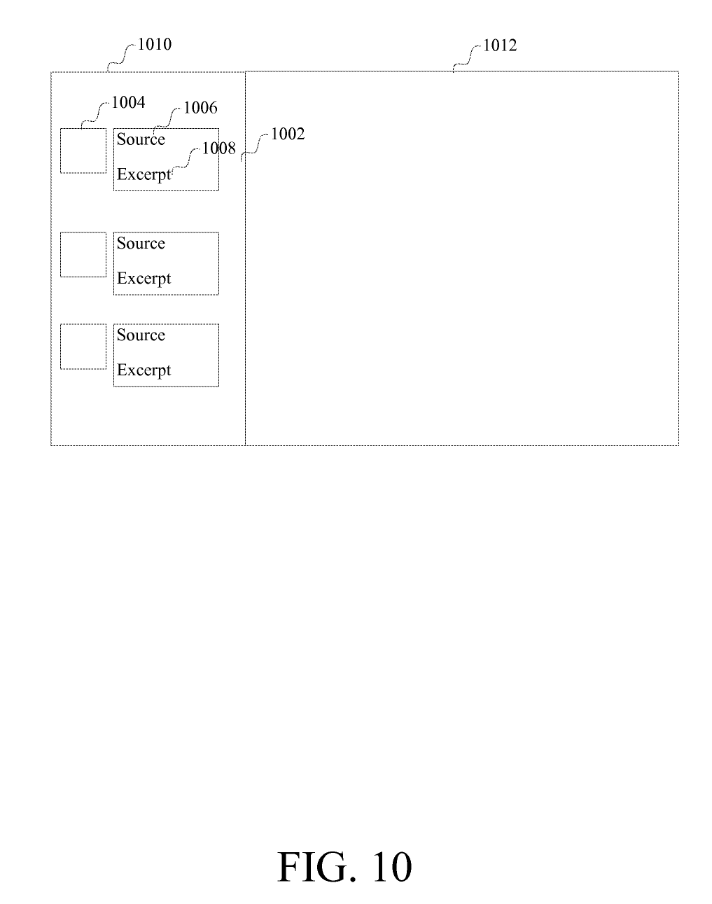

Referring now to FIG. 10, another example graphical user interface is shown. In this example, links also are grouped and sorted, such as by time of access. In this example, each representation 1002 of a link has the same size, and includes an image 1004, source 1006 and brief excerpt 1008. Also in this view, links are displayed in a pane 1010, while the application being used to access the resource associated with any currently selected link is shown in a separate pane 1012.

In such a graphical user interface, the display of the link data in the various groups also can be color coded. For example, a light color bar can indicate ‘today’ and a slightly darker bar can indicate “yesterday”, and slightly darker bar can indicate “last week” entries, and then a black bar can indicate the last group. Also, the display of the groups can be limited to only a few groups, or only the headings of the groups for example, and then after some user manipulation, the information in the groups can be expanded.

Through an application programming interface to access such link data from an operating system, applications other than the link manager and operating system also can provide a graphical user interface supporting similar functionality.

With such a system, link data is stored in a consistent format across applications and resources. As a result, the operating system provides a single mechanism for a heterogeneous set of applications and a heterogeneous set of resources to store link data in a single repository. For multiple computers that are associated with a same user account with a networked storage service, link data is stored consistently across a heterogeneous set of devices as well. Further, link data can be shared among users in a consistent manner.

Having now described an example implementation, a computer with which components of such a system are designed to operate will now be described. The following description is intended to provide a brief, general description of a suitable computer with which such a system can be implemented. The computer can be any of a variety of general purpose or special purpose computing hardware configurations. Examples of well-known computers that may be suitable include, but are not limited to, personal computers, server computers, hand-held or laptop devices (for example, media players, notebook computers, cellular phones, personal data assistants, voice recorders), multiprocessor systems, microprocessor-based systems, set top boxes, game consoles, programmable consumer electronics, network PCs, minicomputers, mainframe computers, distributed computing environments that include any of the above systems or devices, and the like.

FIG. 11 illustrates an example of a suitable computer. This is only one example of a suitable computer and is not intended to suggest any limitation as to the scope of use or functionality of such a computer.

With reference to FIG. 11, an example computer 1100, in a basic configuration, includes at least one processing unit 1102 and memory 1104. The computer may include multiple processing units and/or additional co-processing units such as graphics processing unit 1120. Depending on the exact configuration and type of computer, memory 1104 may be volatile (such as RAM), non-volatile (such as ROM, flash memory, etc.) or some combination of the two. This configuration is illustrated in FIG. 11 by dashed line 1106.

Additionally, computer 1100 may also have additional features/functionality. For example, computer 1100 may also include additional storage (removable and/or non-removable) including, but not limited to, magnetic or optical disks or tape. Such additional storage is illustrated in FIG. 11 by removable storage 1108 and non-removable storage 1110. Computer storage media includes volatile and nonvolatile, removable and non-removable media implemented in any method or technology for storage of information such as computer program instructions, data structures, program modules or other data. Memory 1104, removable storage 1108 and non-removable storage 1110 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by computer 1100. Any such computer storage media may be part of computer 1100.

Computer 1100 may also contain communications connection(s) 1112 that allow the device to communicate with other devices over a communication medium. Communication media typically carry computer program instructions, data structures, program modules or other data in a modulated data signal such as a carrier wave or other transport mechanism and include any information delivery media. The term “modulated data signal” means a signal that has one or more of its characteristics set or changed in such a manner as to encode information in the signal, thereby changing the configuration or state of the receiving device of the signal. By way of example, and not limitation, communication media includes wired media such as a wired network or direct-wired connection, and wireless media such as acoustic, RF, infrared and other wireless media. Communications connections 1112 are devices that interface with the communication media to transmit data over and receive data from communication media, such as a network interface.

Computer 1100 may have various input device(s) 1114 such as a keyboard, mouse, pen, camera, touch input device, and so on. Output device(s) 1116 such as a display, speakers, a printer, and so on may also be included. All of these devices are well known in the art and need not be discussed at length here. Various input and output devices can implement a natural user interface (NUI), which is any interface technology that enables a user to interact with a device in a “natural” manner, free from artificial constraints imposed by input devices such as mice, keyboards, remote controls, and the like.

Examples of NUI methods include those relying on speech recognition, touch and stylus recognition, gesture recognition both on screen and adjacent to the screen, air gestures, head and eye tracking, voice and speech, vision, touch, gestures, and machine intelligence, and may include the use of touch sensitive displays, voice and speech recognition, intention and goal understanding, motion gesture detection using depth cameras (such as stereoscopic camera systems, infrared camera systems, and other camera systems and combinations of these), motion gesture detection using accelerometers or gyroscopes, facial recognition, three dimensional displays, head, eye, and gaze tracking, immersive augmented reality and virtual reality systems, all of which provide a more natural interface, as well as technologies for sensing brain activity using electric field sensing electrodes (EEG and related methods).

Each component of this system that operates on a computer generally is implemented by software, such as one or more computer programs, which include computer-executable instructions and/or computer-interpreted instructions, such as program modules, being processed by the computer. Generally, program modules include routines, programs, objects, components, data structures, and so on, that, when processed by a processing unit, instruct the processing unit to perform particular tasks or implement particular abstract data types. This computer system may be practiced in distributed computing environments where tasks are performed by remote processing devices that are linked through a communications network. In a distributed computing environment, program modules may be located in both local and remote computer storage media including memory storage devices.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The terms “article of manufacture”, “process”, “machine” and “composition of matter” in the preambles of the appended claims are intended to limit the claims to subject matter deemed to fall within the scope of patentable subject matter defined by the use of these terms in 35 U.S.C. §101.

Any or all of the aforementioned alternate embodiments described herein may be used in any combination desired to form additional hybrid embodiments. It should be understood that the subject matter defined in the appended claims is not necessarily limited to the specific implementations described above. The specific implementations described above are disclosed as examples only.

What is claimed is:

1. A computer comprising:
a memory,
a processor connected to the memory and programmed to provide:
an operating system, the operating system comprising:
an interface that receives requests from applications to store link data, and
an interface that receives requests from applications to provide stored link data; and
a link manager that stores link data from multiple applications in a data format in common across the multiple applications and that manages access to the stored link data.

2. The computer of claim 1, wherein the computer is associated with a user account on a networked storage service, wherein when the computer is connected to the networked storage service, stored link data on the computer is synchronized with stored link data of the user account on the networked storage service.

3. The computer of claim 1, wherein the stored link data includes information describing a resource.

4. The computer of claim 1, wherein the stored link data includes an indication of an application used to access the resource.

5. The computer of claim 4, wherein the link manager, in response to a determination that the application used to access the resource is unavailable on the computer, prompts the user to install the application on the computer.

6. The computer of claim 4, wherein the stored link data includes a plurality of links for the same or equivalent resources to be used by different applications.

7. The computer of claim 1, wherein the link manager includes a graphical user interface for presenting information about stored link data on a display and a mechanism enabling modification of the information.

8. The computer of claim 3, wherein the information about the resource includes metadata generated by an application that accessed the resource.

9. The computer of claim 3, wherein the information about the resource includes metadata received from a user.

10. An article of manufacture comprising:
computer storage, with computer program instructions stored on the computer storage, wherein, when the computer program instructions are processed by a processing device of a computer, the computer is configured to provide:
an operating system, the operating system comprising:
an interface that receives requests from applications to store link data, and
an interface that receives requests from applications to provide stored link data; and
a link manager that stores data from multiple applications in a data format in common across the multiple applications and that manages access to the stored link data.

11. The article of manufacture of claim 10, wherein the computer is associated with a user account on a networked storage service, wherein when the computer is connected to the networked storage service, stored link data on the computer is synchronized with stored link data of the user account on the networked storage service.

12. The article of manufacture of claim 10, wherein the stored link data includes information describing a resource.

13. The article of manufacture of claim 10, wherein the stored link data includes an indication of an application used to access the resource.

14. The article of manufacture of claim 13, wherein the link manager, in response to a determination that the application used to access the resource is unavailable on the computer, prompts the user to install the application on the computer.

15. The article of manufacture of claim 13, wherein the stored link data includes a plurality of links for the same or equivalent resources to be used by different applications.

16. A networked storage service, comprising:
one or more server computers connected to one or more storage devices on which data is stored in association with a plurality of user accounts;
wherein the network storage service has stores data from computer associated with user accounts, such data including link data stored in a data format in common across multiple applications and multiple computers.

17. The networked storage service of claim 16, wherein when a computer for a user account is connected to the networked storage service, stored link data on the computer is synchronized with stored link data of the user account on the networked storage service.

18. The networked storage service of claim 17, wherein the stored link data includes information describing a resource.

19. The networked storage service of claim 17, wherein the stored link data includes an indication of an application used to access the resource.

20. The networked storage service of claim 17, wherein the stored link data includes a plurality of links for the same or equivalent resources to be used by different applications.
